(19) United States
(12) Patent Application Publication
(10) Pub. No.: US 2025/0198896 A1
(43) Pub. Date: Jun. 19, 2025

(54) RHEOLOGICAL DOSING AND MONITORING SYSTEMS AND METHODS

(71) Applicant: Purdue Research Foundation, West Lafayette, IN (US)

(72) Inventors: Mohammadhasan Sasar, Blacksburg, VA (US); Maria Caterina Santagata, West Lafayette, IN (US)

(73) Assignee: Purdue Research Foundation, West Lafayette, IN (US)

(21) Appl. No.: 18/979,377

(22) Filed: Dec. 12, 2024

Related U.S. Application Data
(60) Provisional application No. 63/612,020, filed on Dec. 19, 2023.

(51) Int. Cl. G01N 11/14; G01N 11/00

(52) U.S. Cl. CPC G01N 11/14; G01N 2011/0046; G01N 2011/008

(57) ABSTRACT

A system includes a rheometer probe, a material sample holder, a material feed system, and an accessory ring to perform rheometric experiments. The rheometer probe is configured to extend into the material sample holder to perform a rheological analysis on a material sample therein. The material feed system includes a first material reservoir, a feed implement, and a pump. The feed implement is fluidly coupled with the first material reservoir and positioned to extend into the material sample holder. The pump is operable to selectively transfer materials from the first material reservoir to the material sample holder via the feed implement. The accessory ring is positioned over the open end of the material sample holder and includes a first opening therethrough configured to support the rheometer probe and a second opening therethrough configured to support the feed implement.

### CROSS-REFERENCE TO RELATED APPLICATIONS

This application is related to and claims the priority benefit of U.S. Provisional Patent Application No. 63/612,020, entitled “Rheological Dosing and Monitoring Systems and Methods,” filed Dec. 19, 2023, the contents of which are hereby incorporated by reference in their entirety into the present disclosure.

### TECHNICAL FIELD

The present application relates to rheology, and more particularly to in-rheometer automated chemical dosing and reaction monitoring of fluid and semi-solid materials.

### BACKGROUND

This section introduces aspects that may help facilitate a better understanding of the disclosure. Accordingly, these statements are to be read in this light and are not to be understood as admissions about what is or is not prior art.

A rheometer is a scientific instrument used for assessing and understanding the flow and deformation properties of materials, with a particular focus on liquids and soft solids. Its central purpose lies in unraveling the rheological characteristics of substances, which describe how they respond to external forces and conditions, such as shear stress, and strain. These measurements play an important role in providing insights into how materials behave and perform in diverse applications.

Rheometers perform several functions. First, they help determine a material's viscosity, revealing its resistance to flow, which is essential for maintaining product consistency in industries like food processing. Additionally, they assess a material's elasticity, indicating its ability to revert to its original shape after deformation, thus being crucial in fields like polymer manufacturing and the development of elastomers. Rheometers also detect material behavior, such as shear thinning, where a material's viscosity decreases as the shear rate increases, which is valuable information for products like paints and cosmetics.

Furthermore, rheometers are instrumental in identifying the yield stress in certain materials, representing the critical stress level at which the material begins to flow. This is particularly significant in applications like drilling fluids within the oil and gas industry. Material characterization, including responses to changing temperature and pressure, is another role of rheometers, aiding the development and optimization of processes and products across industries such as pharmaceuticals, cosmetics, and materials science. Moreover, these instruments are employed in quality control processes, ensuring that products meet specific rheological standards and perform as intended, particularly in industries where maintaining product consistency is paramount, such as adhesives, inks, and coatings. As such, rheometers serve as important tools for examining and quantifying how materials respond to different conditions, enabling informed decisions regarding material selection, product design, and process optimization. They find applications in a wide array of scientific disciplines and industrial sectors.

One particular type of rheometer is a rotational rheometer. A rotational rheometer operates by immersing a spindle or rotor into the fluid being tested. The spindle is then rotated at a constant speed, and the torque required to maintain this rotation is measured. The level of torque is directly related to the resistance the fluid exerts against the spinning spindle. By measuring this torque and knowing the rotational speed of the spindle, the rotational rheometer can calculate the viscosity of the fluid using various mathematical models, such as Newton's law of viscosity. It should be understood that, while rotational rheometers are described, rotary viscometers are similar devices which perform similar functions, and accordingly suffer from similar setbacks.

However, there are currently no adequate methods for controlled dosing of an additive in a scientific laboratory rheometer or viscometer while conducting real-time measurements. Therefore, there is a need for improved rheological systems and methods for real-time chemical dosing and reaction monitoring.

### SUMMARY

Described herein are systems and methods which can improve the capabilities of rheometers and viscometers for studying real-time chemical reactions. The improvements can enable, among other things, controlled injections of dosages of chemicals into rheometer measuring cups, as well as injections or evacuations of bulk material into rheometer measuring cups. In one aspect, a system can include a rheometer having a rheometer probe, a material sample holder having an open end, a material feed system, and an accessory ring. The rheometer probe can be configured to extend through the open end into the material sample holder to perform a rheological analysis on a material sample within the material sample holder. The material feed system can include a first material reservoir, a feed implement, and a pump. The feed implement can be fluidly coupled with the first material reservoir and positioned to extend through the open end into the material sample holder. The pump can be operable to selectively transfer materials from the first material reservoir to the material sample holder via the feed implement. The accessory ring can be positioned over the open end of the material sample holder and can include a first opening therethrough configured to support the rheometer probe and a second opening therethrough configured to support the feed implement.

In another aspect, a method of performing an analysis on a material sample using a rheological system is described. The method can include various steps such as lowering the rheometer probe into the sample holder such that the rheometer probe is at least partially submerged into the material sample and activating a rotation of the rheometer probe, determining a first rheological material characterization of the material sample. Additionally, the method can include transferring a predetermined dose of an additive from the material reservoir into the sample holder using the material feed implement while the rheometer probe rotates and determining a second rheological material characterization of the material sample.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A depicts a schematic diagram of one exemplary rheological system, showing the measuring probe and feed implement in an initial, raised position;

FIG. 1B depicts a schematic diagram of the rheological system of FIG. 1A, showing the measuring probe and feed implement in a lowered position;

FIG. 2A depicts a perspective schematic view of one exemplary accessory ring configured to couple with a rheometer cup or sample holder;

FIG. 2B depicts a top plan view of the accessory ring of FIG. 2A;

FIG. 2C depicts a bottom plan view of the accessory ring of FIG. 2A;

FIG. 3 depicts a schematic view of another exemplary rheological system, showing the measuring probe and feed implement in a lowered position and a disposal implement in a lowered position;

FIG. 4 depicts an example timeline of a multi-stage rheological experimental setup process applicable for use with one or more of the rheological systems described;

FIG. 5 depicts a series of images taken from the surface of an experimental FFT sample, the images collected by an optical monitoring system that is documenting the release of bitumen as a result of the addition of a polymeric flocculant, with portion (a) showing untreated FFT, and the remainder of the portions showing treated FFT following the injection of (b) dose 4, (c) dose 10, (d) dose 12, (e) dose 16, and (f) dose 20 of the flocculant;

FIG. 6 depicts a graphical representation showing the quantification of bitumen released by FFT with increasing dosage of the polymer flocculant based on the analysis of experimental images obtained using one or more of the optical systems described;

FIG. 7A depicts a graphical representation showing rheological amplitude sweep experimental results (storage modulus (G′) and loss modulus (G″) versus shear strain) documenting an evolution of rheological response of an FFT with the injection of the polymeric flocculant, showing the results taken from an untreated (raw) FFT;

FIG. 7B depicts a graphical representation showing rheological amplitude sweep experimental results (storage modulus (G′) and loss modulus (G″) versus shear strain) documenting an evolution of rheological response of an FFT with the injection of the polymeric flocculant, showing the results taken from a treated FFT following the injection of dose #4 of the polymeric flocculant;

FIG. 7C depicts a graphical representation showing rheological amplitude sweep experimental results (storage modulus (G′) and loss modulus (G″) versus shear strain) documenting an evolution of rheological response of an FFT with the injection of the polymeric flocculant, showing the results taken from a treated FFT following the injection of dose #10 of the polymeric flocculant;

FIG. 7D depicts a graphical representation showing rheological amplitude sweep experimental results (storage modulus (G′) and loss modulus (G″) versus shear strain) documenting an evolution of rheological response of an FFT with the injection of the polymeric flocculant, showing the results taken from a treated FFT following the injection of dose #12 of the polymeric flocculant;

FIG. 7E depicts a graphical representation showing rheological amplitude sweep experimental results (storage modulus (G′) and loss modulus (G″) versus shear strain) documenting an evolution of rheological response of an FFT with the injection of the polymeric flocculant, showing the results taken from a treated FFT following the injection of dose #16 of the polymeric flocculant, further showing the crossover point (i.e., where G′=G″) and the G′₀ points; and

FIG. 7F depicts a graphical representation showing rheological amplitude sweep experimental results (storage modulus (G′) and loss modulus (G″) versus shear strain) documenting an evolution of rheological response of an FFT with the injection of the polymeric flocculant, showing the results taken from a treated FFT following the injection of dose #20 of the polymeric flocculant.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

In existing rheometric systems, the only way to test the effects of multiple additive doses is to prepare and separately test multiple different samples. A few important shortcomings of the existing approach are the sample-to-sample variabilities, time consuming cleaning and testing procedures, and the inability to collect real-time rheological datasets during and after additive dosing. Thus, improved systems and methods which provide for controlled dosing of additives in scientific laboratory rheometers (e.g., rotational rheometers or rotary viscometers) while conducting real-time rheological measurements are needed.

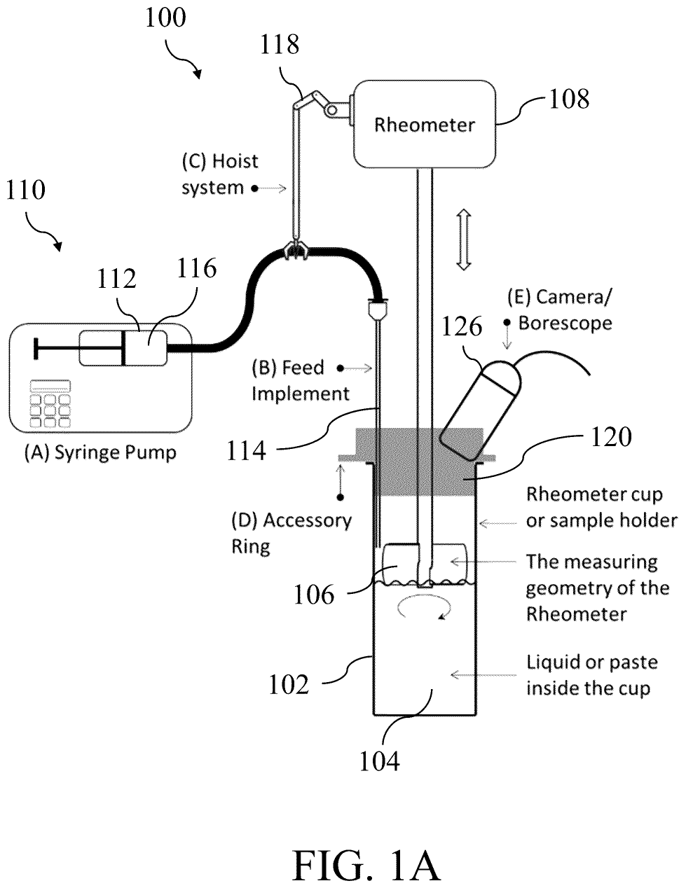

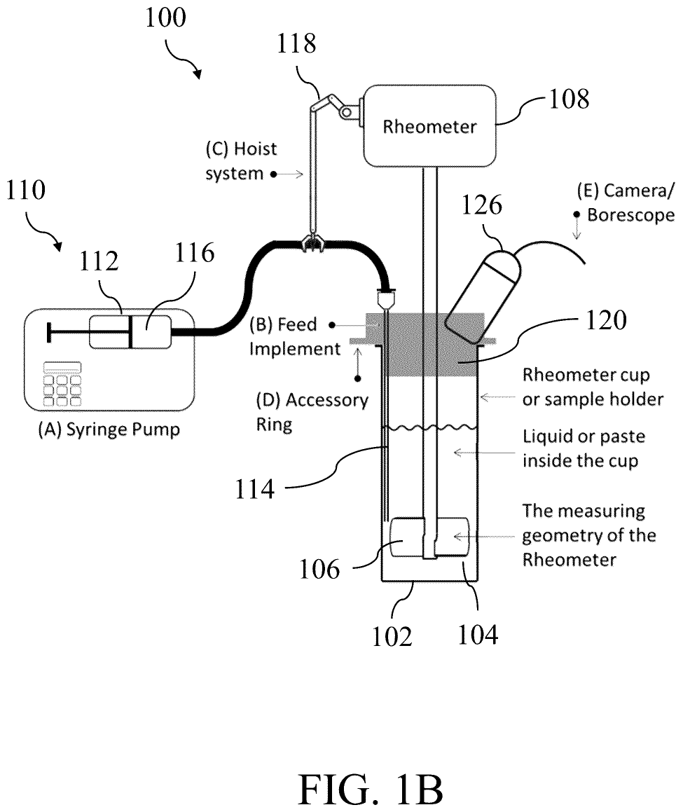

To that end, FIGS. 1A-1B show one example of a rheometric system (100). The system (100) includes a rheometer cup or sample holder (102) which is configured to hold a material sample (104), a rheometer probe (106) coupled with and driven by a rheometer (108), and a material delivery system (110). The material delivery system (110) includes a pump (112) and a feed implement (114), the pump (112) being operable to deliver the material sample (104) into the sample holder (102) via the feed implement (114). In some embodiments, the material delivery system (110) further includes a material sample reservoir (116) housed within it or coupled with it, while in alternative embodiments the pump (112) can be coupled with a tubing that may be selectively inserted into one or more different types of material sample reservoirs. The material sample reservoir (116) and pump (112) may collectively be provided in the form of a syringe pump (as shown), or may be any alternative known material sample reservoir (116) and pump (112) combination commonly used in the art.

Further, the rheometer (108) may be operatively coupled with a hoist system (118) for selectively raising and lowering the feed implement (114) into and out of the sample holder (102), or alternatively to a higher or lower position within the sample holder (102). FIG. 1A shows the hoist system (118) raising the feed implement (114) to a higher position (i.e., further from the bottom of the sample holder (102)), while FIG. 1B shows the hoist system (118) lowering the feed implement (114) to a lower position (i.e., closer to the bottom of the sample holder (102)). Accordingly, the rheometer (108) may generate and send control signals to operate the hoist system (118) set the feed implement (114) to the higher position (see, FIG. 1A) while the pump (112) is deactivated (i.e., not pumping a material sample (104) into the sample holder (102)) or it may set the feed implement (114) to the lower position (see, FIG. 1B) while the pump (112) is activated (i.e., pumping a material sample (104) into the sample holder (102)). The ability of the feed implement (114) to move vertically while injecting allows for uniform dosing and mixing of chemicals into high-viscosity materials where otherwise uniform mixing can be difficult or impossible to achieve. In an alternative embodiment (not shown), the rheometer (108) may instead be operatively coupled with a movable stage that supports the sample holder (102) rather than, or in addition to, being coupled with the hoist system (118), and the movable stage may selectively raise or lower the sample holder (102) relative to a stationary rheometer probe (106) or feed implement (114) to accomplish the same function.

The material flow through the feed implement (114) is under computer software control, such as by an autonomous processing device or user input device associated with the rheometer (108), so the feed implement (114) can be advanced and retracted relative to the sample holder (102) along with the rheometer probe (106). These capabilities allow adjustable feed and dosing protocols and custom dosing profiles that can be synchronized with mixing operations and rheological measurements.

The pump (112) (e.g., a syringe pump) coupled with the rheometer (108) is controlled either by the user or autonomously by the same software that collects data from the rheometer (108). The pump (112) can be configured to inject materials (e.g., additives or bulk fluid/semi-solid paste) in predetermined volumes into and out of the sample holder (102). In one experimental system, a Harvard Apparatus Model 44 Programmable Syringe Pump and a 20 cubic centimeter (cc) stainless steel syringe were used, and the pump was directly controlled by the rheometer (108) software. Similar commercially available syringe pumps can be used instead. Depending on the application, additional syringe pumps can be used to introduce different additives or to evacuate the measuring cup, as will be described below.

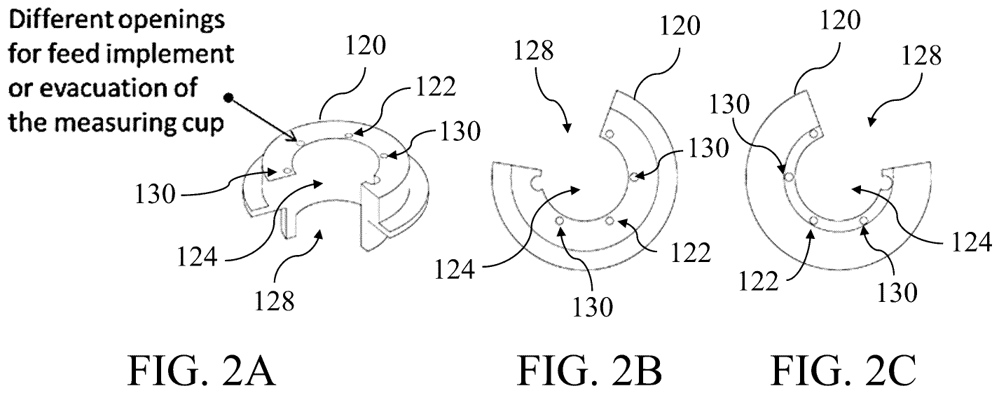

The sample holder (102) can be coupled with additional components which may assist with the material feeding and reaction monitoring or dosing during an operation of the rheometer (108). Particularly, an accessory ring (120) may be shaped to fit across the opening of the sample holder (102). The accessory ring (120) can be devised to receive a plurality of different devices at the opening of the sample holder (102). For example, as shown in FIGS. 2A-2C, the accessory ring (120) may include openings (122, 124) to receive the feed implement (114) and rheometer probe (106), respectively, therethrough such that the feed implement (114) and rheometer probe (106) are able to freely translate between their raised positions (see, FIG. 1A) and their lowered positions (see, FIG. 1B). Additional devices, such as a camera or borescope (126) (see, FIGS. 1A-1B) may be coupled with the accessory ring (120) for real-time monitoring of experiments. Accordingly, the camera or borescope (126) may slot into an opening (128) of the accessory ring (120) to be affixed into place. The accessory ring also ensures that the feed implement (114) translates without obstructing the rheometer probe (108). The accessory ring (120) may be formed of non-porous materials such as stainless steel or hard plastics that can be cleaned and re-used if necessary, and may include additional openings (130) for the inclusion of additional accessories, if needed.

As such, the accessory ring (120) supports a plurality of components which collectively provide real-time control of material feed into the rheometer system (100), and which facilitate reaction monitoring of fluid and semi-solid materials during rheological analyses. In one embodiment, as shown, the feed implement (114) includes a needle to introduce additives to a material sample (104) before or during an analysis that alters the rheological properties of a base medium. In other embodiments, the feed implement (114) can be a larger tube used to introduce a bulk medium material sample (104). In the illustrated embodiments of FIGS. 2A-2C, the accessory ring (120) is designed for one particular class of commercially available rheometers (i.e., Anton Paar Modular Compact Rheometers). However, the accessory ring (120) may be modified to fit other devices as needed.

One example of an optical system, such as the camera or borescope (126) as described, is a Teslong Auto Focus Borescope Camera with 5.0 Megapixel resolution and focal distance of 1 inch to 100 feet. Alternative optical systems with similar dimensions could be used instead. The relatively small diameter of the example camera probe (i.e., 12.5 mm/0.49 inch) enables its placement within close proximity of the rheometer probe (106) without interfering with the rheometer (108) operation during the mixing and measurement stages. The integrated system (100) having the ability to support customizable testing methodology allows for rheological measurements using advanced laboratory rheometers while fluid and semi-solid materials are mixed with additives or are processed. Real-time rheological measurements may be used to develop a control strategy for fluid/semi-solid processing or to study the chemical/structural modifications of a fluid/semi-solid material as it develops through the manufacturing process.

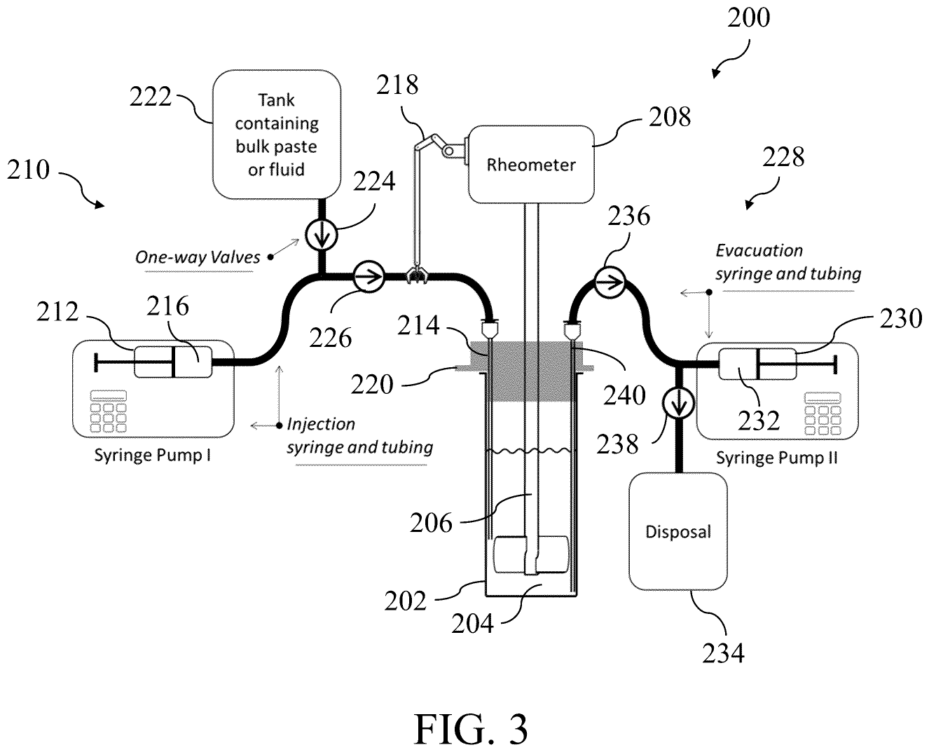

Shown in FIG. 3 is another exemplary rheometric system (200) which includes many of the same components of rheometric system (100) but includes additional optional components. For example, the system (200) similarly includes a rheometer cup or sample holder (202) which is configured to hold a material sample (204), a rheometer probe (206) coupled with and driven by a rheometer (208), and a material delivery system (210). The material delivery system (210) includes a pump (212) and a feed implement (214), the pump (212) being operable to deliver the material sample (204) into the sample holder (202) via the feed implement (214). In some embodiments, the material delivery system (210) includes a material sample reservoir (216) housed within it or coupled with it, while in alternative embodiments the pump (212) can be coupled with tubing that may be selectively inserted into one or more different types of material sample reservoirs. The material sample reservoir (216) and pump (212) may collectively be provided in the form of a syringe pump (as shown), or may be any alternative known material sample reservoir (216) and pump (212) combination commonly used in the art. Further, the rheometer (208) may be operatively coupled with a hoist system (218) for selectively raising and lowering the feed implement (214) into and out of the sample holder (202), or alternatively to a higher or lower position within the sample holder (202), through an accessory ring (220) similar to accessory ring (120). While not shown in FIG. 3, a camera/borescope may be included similar to that of system (100).

Material delivery system (210) of rheometric system (200) can include additional components, such as a second sample reservoir (222) fluidly coupled with the feed implement (214) along with the first sample reservoir (216). Sample reservoir (222) may include a second pump (not shown) that is selectively operable to force materials from the sample reservoir (222) toward the feed implement (214), or the materials from sample reservoir (222) may be moved through operation of the one-way valves (224, 226) and the pump (212). Sample reservoir (222) may contain a volume of material, a particular fluid, a paste, or a chemical reaction vessel where a quantity of material is being processed. As such, the system (200) may intermittently or continuously draw materials from the second sample reservoir (222) for testing. In some such embodiments, one sample reservoir (e.g., sample reservoir (222)) can be filled with a bulk paste or fluid, while another sample reservoir (e.g., sample reservoir (216)) can be filled with additives for selective dosing during an experiment, or both reservoirs may be filled with the same materials. In some versions, additional pumps and feed implements may be included to provide additional capabilities to add different materials and/or additives during an experiment. One or more one-way valves (224, 226) may also be included in the tubing system of the material delivery system (210) to force materials and additives through the tubing system in the correct flow directions.

Rheometric system (200) can also include a material evacuation system (228) that is operable to remove materials (204) from the sample holder (202) during or after an experiment is completed. The material evacuation system (228) can include various components or combinations thereof, such as a pump (230), a first sample reservoir (232), a second sample reservoir (234), one or more one-way valves (236, 238) operable to force materials through the tubing system in the correct flow directions, and a disposal implement (240). In use, the pump (230) may be operated to pull materials (204) from the sample holder (202) via the disposal implement (240) (which may be inserted or held in place through one of the openings (130) of the accessory ring (120)), and the one-way valves (236, 238) may be operated to move materials between the sample reservoirs (232, 234). As such, the system (200) may be configured to autonomously run experiments from start to finish by inserting bulk materials, operating the rheometer probe (206), dosing the materials (204) during the experiment while optionally using optical means (e.g., camera/borescope (126)) to monitor the experiment, before disposing of the materials once the experiment is completed. Finally, another experiment may be subsequently run.

In use, the testing methodology and associated testing protocols may vary depending on the scope of the tests. Three sample protocols are described below. In the first sample protocol, using the rheometric system (100) shown in FIGS. 1A-1B and described above, a known volume of a liquid or paste is placed inside the sample holder (102). When deciding the initial volume of the material (104), the user will take into account the volume of additives that is going to be injected to ensure that the total volume of the holder (102) is not exceeded. The rheometer probe (106) and the feed implement (114) are immersed inside the initial material (104) as shown in FIG. 1B. To begin the test, the rheometer probe (106) begins rotating at a pre-determined RPM to create a vortex inside the holder (102). The rheometer (108) then activates the pump (112) to introduce a predetermined dose of the desired additive from the reservoir (116) through the feed implement (114). The rheological measurements can be performed during both the rheometer mixing action and after a set amount of time is allowed to pass for the chemical additive to show its impact. These steps can be repeated as necessary. This protocol is recommended if there are no concerns about the uniform distribution of the additive in the holder (102), such as in cases in which the initial material (104) has low viscosity, or the additive is highly soluble in the initial material, or when there are no limitations for using high RPMs for creating a vortex inside the holder (102).

If there are concerns about the uniform distribution of the additive within the base medium (for example due to high viscosity of the base material), a different protocol may be used. As a first step, using the rheometric system (100), the probe (106) is raised above its normal measuring position as shown in FIG. 1A. This places the probe (106) and the feed implement (114) near the top of the material line in the holder (102). Next, the probe (106) is lowered to its measuring position at a fixed rate while rotating at a pre-determined RPM, to reach the position shown in FIG. 1B. The pump (112) is controlled by adjusting the injection rate so that the predetermined volume of additive from the reservoir (116) is introduced into the holder (102) during the probe-lowering step. Rheological measurements begin when the probe (106) reaches the measuring position. At the end of the test, the feed implement (114) and the probe (106) can be lifted back to the initial position as shown in FIG. 1A. The length of the feed implement (114) and the accessory ring (120) are designed to ensure that the tip of the feed implement (114) dispenses the polymer at the top corner of the blade of the probe (106) for consistent distribution of the additive or other materials. The accessory ring (120) can accommodate feed implements of different diameters. The steps described above can be repeated as necessary to allow the injection of multiple additive doses. The volume of the holder (102) is the only limiting factor on how much additive or material can be added.

Rheometric system (200), as shown in FIG. 3, may be used for experiments which utilize both injection and evacuation of materials (204) into and out from the sample holder (202). In this testing protocol, the rheometer probe (206) is not required to move vertically. The probe (206) is inside the holder (202) in the lower position (similar to the position shown in FIG. 1A for system (100)), but the holder (202) is initially empty. Two pumps (212, 230) are used, one pump (212) for injection, the second pump (230) for evacuation, with associated tubing and one-way valves (224, 226, 236, 238). To start, the first pump (212) draws the fluid or paste from a sample reservoir (222) and injects it into the holder (202). Once the holder (202) is full, the rheometer (208) can start performing the desired rheological tests. Once the rheological measurements are completed, the second pump (230) is used to evacuate the holder (202). These steps can be repeated as needed on the contents of the holder (202). Moreover, if the holder (202) is a chemical reaction vessel, the rheological data can be used for quality control or for reaction path monitoring of the process occurring inside the holder (202).

The system (100) and testing methodology described above were validated for the treatment by a polymeric flocculant of fluid fine tailings (FFTs, clay-water mixtures containing residual organics) produced by one particular type of mining operation. Flocculation with polymeric flocculants has been used to accelerate dewatering of FFTs. As the effectiveness of the treatment is very sensitive to the polymer dose, there is significant interest in developing methods that permit to rapidly identify the optimum polymer dose that corresponds to the maximum water release. While the test results presented below pertain to this specific process and materials, this example case study supports the use of the integrated system as a process control tool for a broad range of applications in different industries (e.g., food and pharmaceutical).

The testing protocol included a 30-gram (˜25 mL) FFT sample placed in the holder (102) for testing. To start, the probe (106) was raised 30 mm above the normal measuring position. Then, the probe (106) was lowered toward its measuring position at 1 mm/sec while rotating at 320 rpm. Rheological measurements began promptly when the probe (106) was at the measuring position. In the tests presented, such measurements comprised a 30-minute pre-shear stage, followed by a 5-minute time sweep and a large amplitude oscillatory sweep. These tests are used to characterize the response of the raw (untreated) material. At the end of the rheological tests, the feed implement (114), and the probe (106) were lifted to the higher position as shown in FIG. 1A. The probe (106) was then lowered again toward its measuring position (see, FIG. 1B) using the same procedure as before. In this case, however, the rheometer (108) activated the pump (112) to inject a 0.2 mL volume of polymer (dose #1). The injection is completed during the 30 seconds required for the probe (106) to be lowered to its measuring position. Once the probe (106) was at the measuring position, the time sweep, and large amplitude oscillatory sweep rheological tests were repeated to characterize the behavior of the base material treated with one 0.2 ml dose of the polymer. The polymer injection/mixing and rheological testing stages are then repeated 19 additional times to characterize the behavior of the material with increasing polymer addition and mixing.

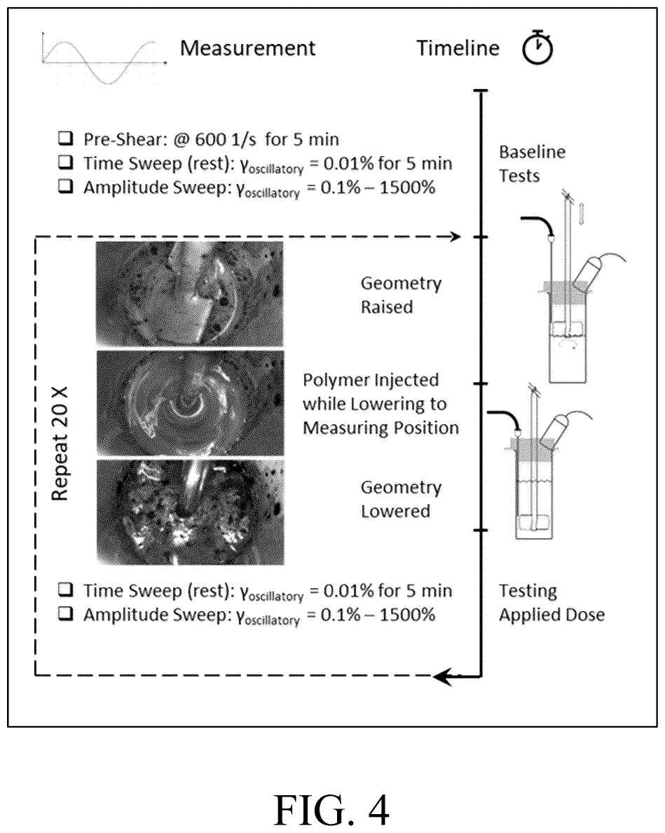

Over the entire duration of the test, a Teslong Auto Focus Borescope Camera with 5.0 Megapixel resolution and focal distance of 1 inch to 100 ft is used to take images of the sample surface. The small diameter of the probe (12.5 mm/0.49 inch) enabled placement of the borescope in close proximity of the measurement probe without interfering with the rheometer operation during mixing and measurement stages. The procedure and the timeline of the multistage test described here are shown schematically in FIG. 4. The embedded photos show the rheometer measuring tool at the top of the sample and while it is being lowered to the measuring position, and the sample during the rheological tests.

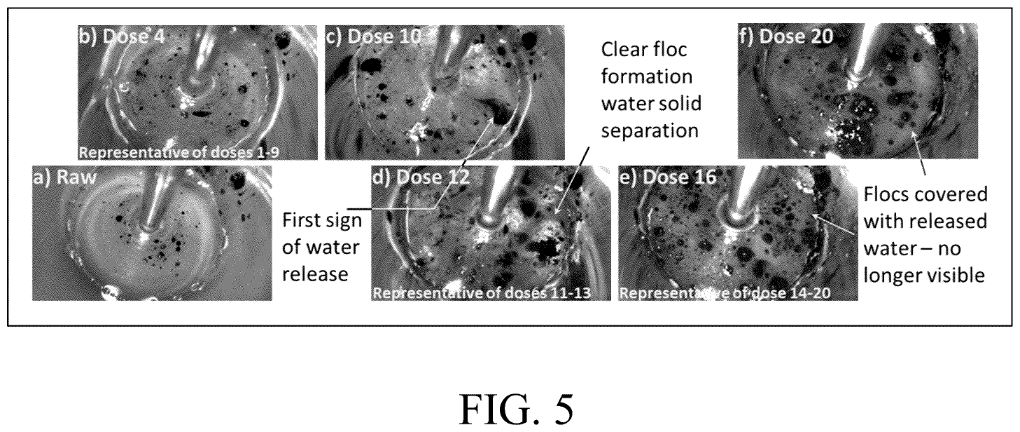

FIG. 5 shows select images of the sample surface collected by the optical monitoring system over the duration of the test. They refer to the (a) raw (untreated) FFT sample, and the same sample after the rheological testing stages following the injection of (b) dose #4, (c) dose #10, (d) dose #12, (e) dose #16 and (f) dose #20 of the polymeric flocculant. The images permit clear identification of the polymer dosage corresponding to the onset of water release (optimum polymer dose). In all images, the darker areas correspond to droplets of the residual bitumen contained in the tailings. Bitumen is a known environmental contaminant and there is significant interest in understanding the effect of polymer treatment on its fate.

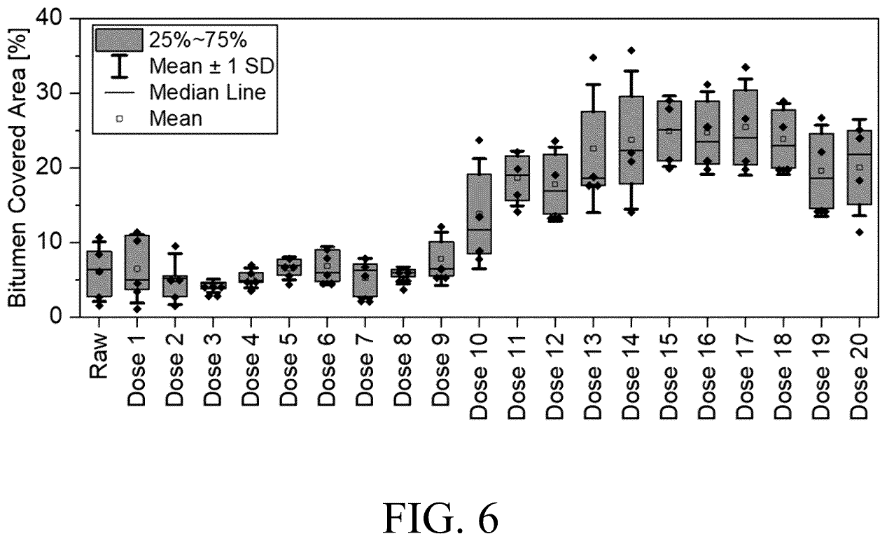

FIG. 6 shows the results of an analysis of the images of the sample surface collected using the borescope camera at the end of each testing stage for four independent samples of the same FFT. The image processing software was used to quantify the bitumen released because of the injection of each polymer dose. It is seen that the addition of the polymer led to the release of the bitumen contained in the tailings.

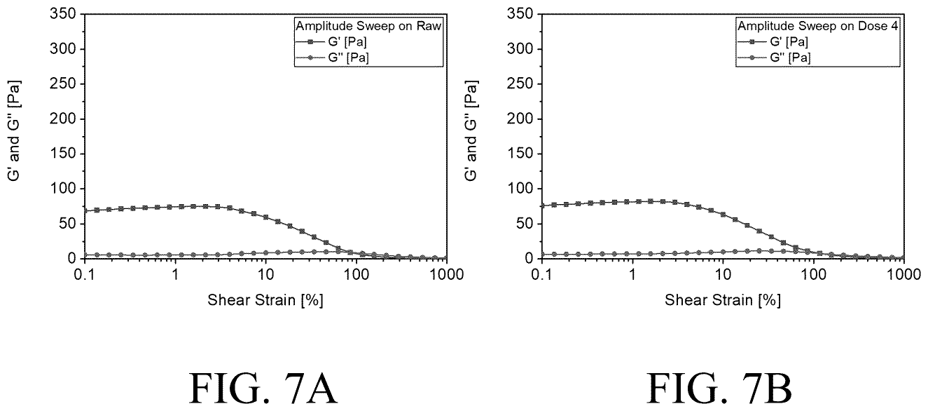

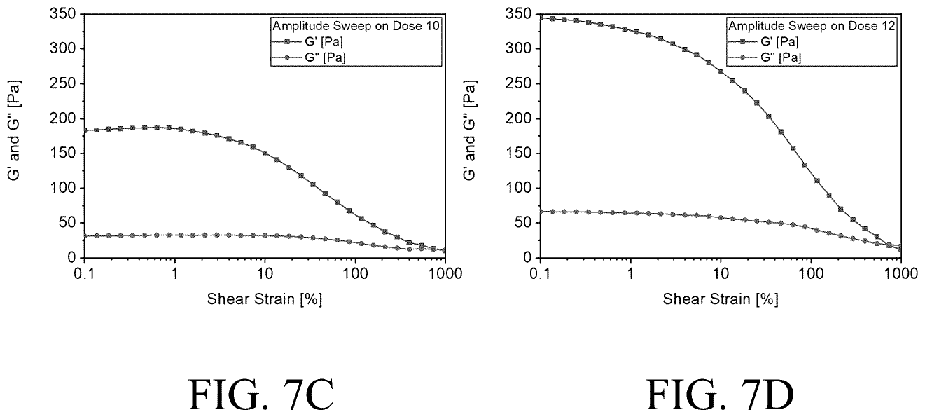

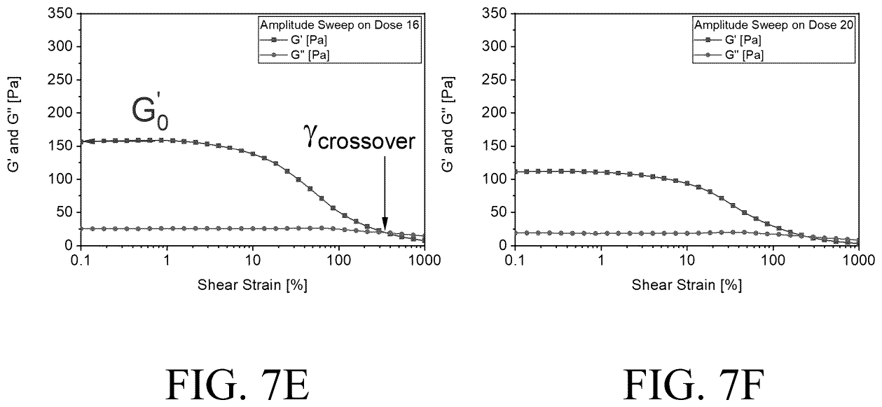

FIGS. 7A-7F show the curves of storage modulus (G′) and loss modulus (G″) versus shear strain obtained from the amplitude sweeps performed on a sample of raw (untreated) FFT (FIG. 7A), and on the same sample following the injection of dose #4 (FIG. 7B), dose #10 (FIG. 7C), dose #12 (FIG. 7D), dose #16 (FIG. 7E) and dose #20 (FIG. 7F) of the polymeric flocculant. The data clearly illustrate the evolution in rheological behavior with the addition of the polymer dose. Importantly, they highlight the distinct rheological response (e.g., maximum value of G′ in the linear visco-elastic region (G′₀) and maximum value of the cross-over shear strain (γ_{cross})) observed in correspondence to the optimum water release dose. Overall, these results illustrate the test for monitoring of a time-dependent process, a capability that can be leveraged in a range of applications in various industries.

Accordingly, the systems and methods described above are advantageous as they (1) allow the study of reactions involving dosing of single or multiple additive in fluids or semi-solid pastes to be performed inside advanced laboratory rheometers, (2) enable continuous collection of rheological data during a process (e.g., a chemical process resulting from introduction of an additive into a paste or liquid), allowing continuous reaction monitoring, (3) reduce the time and manual labor required for dosing or titration-like tests with one or more additives in the lab by automating the process and allowing gradual dosing of one or more additives using a single sample, (4) eliminate issues associated with sample-to-sample variability (e.g., instead of preparing multiple samples with different doses of one or more additives, a single sample can be used, increasing the additive doses as desired while studying the rheology of the resulting material), (5) enable bulk sample placement and evacuation in the rheometer measuring cup from a large tank or continuous source of material for repeated quality control of the material, and (6) expand the capabilities of laboratory rheometers by providing real-time rheological and optical data during material processing/manufacturing, among other benefits over existing rheological systems.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/we claim:

1. An apparatus, comprising:
(a) a rheometer including a rheometer probe;
(b) a material sample holder having an open end, wherein the rheometer probe is configured to extend through the open end into the material sample holder to perform a rheological analysis on a material sample within the material sample holder;
(c) a material feed system, including:
(i) a first material reservoir,
(ii) a feed implement fluidly coupled with the first material reservoir, wherein the feed implement is positioned to extend through the open end into the material sample holder, and
(iii) a first pump operable to selectively transfer materials from the first material reservoir to the material sample holder via the feed implement; and
(d) an accessory ring positioned over the open end of the material sample holder, wherein the accessory ring includes at least one opening therethrough configured to support at least one of the rheometer probe and the feed implement.

2. The apparatus of claim 1, wherein the accessory ring includes a first opening therethrough configured to support the rheometer probe and a second opening therethrough configured to support the feed implement.

3. The apparatus of claim 2, further comprising an imaging device positioned adjacent to the open end of the material sample holder and operable to image the material sample within the material sample holder, wherein the accessory ring includes a third opening therethrough configured to support the imaging device.

4. The apparatus of claim 1, further comprising a hoist system coupled with the feed implement, wherein the hoist system is configured to selectively translate the feed implement between a raised position and a lowered position relative to the material sample holder.

5. The apparatus of claim 1, further comprising a second material reservoir fluidly coupled with the feed implement, wherein the first pump is operable to selectively transfer materials from the second material reservoir to the material sample holder via the feed implement.

6. The apparatus of claim 1, further comprising a material evacuation system, including:
(a) a third material reservoir,
(b) an evacuation implement fluidly coupled with the third material reservoir, wherein the evacuation implement is positioned to extend through the open end into the material sample holder, and
(c) a second pump operable to selectively transfer materials from the material sample holder to the third material reservoir via the evacuation implement.

7. The apparatus of claim 6, wherein the accessory ring includes a fourth opening therethrough configured to support the evacuation implement.

8. The apparatus of claim 6, further comprising a fourth material reservoir fluidly coupled with the evacuation implement, wherein the second pump is operable to selectively transfer materials from the material sample holder to the fourth material reservoir via the evacuation implement.

9. The apparatus of claim 1, wherein the first pump includes a syringe pump.

10. An apparatus, comprising:
(a) a rheometer including a rheometer probe;
(b) a material sample holder having an open end, wherein the rheometer probe is configured to extend through the open end into the material sample holder to perform a rheological analysis on a material sample within the material sample holder;
(c) a material feed system, including:
(i) a first material reservoir,
(ii) a feed implement fluidly coupled with the first material reservoir, wherein the feed implement is positioned to extend through the open end into the material sample holder, and
(d) an accessory ring positioned over the open end of the material sample holder, wherein the accessory ring includes a first opening therethrough configured to support the rheometer probe and a second opening therethrough configured to support the feed implement.

11. The apparatus of claim 10, wherein the material feed system includes a first pump operable to selectively transfer materials from the first material reservoir to the material sample holder via the feed implement.

12. The apparatus of claim 11, further comprising a second material reservoir fluidly coupled with the feed implement, wherein the first pump is operable to selectively transfer materials from the second material reservoir to the material sample holder via the feed implement.

13. The apparatus of claim 12, further comprising a material evacuation system, including:
(a) a third material reservoir,
(b) an evacuation implement fluidly coupled with the third material reservoir, wherein the evacuation implement is positioned to extend through the open end into the material sample holder, and
(c) a second pump operable to selectively transfer materials from the material sample holder to the third material reservoir via the evacuation implement.

14. The apparatus of claim 13, wherein the accessory ring includes a fourth opening therethrough configured to support the evacuation implement.

15. The apparatus of claim 13, further comprising a fourth material reservoir fluidly coupled with the evacuation implement, wherein the second pump is operable to selectively transfer materials from the material sample holder to the fourth material reservoir via the evacuation implement.

16. The apparatus of claim 10, comprising an imaging device positioned adjacent to the open end of the material sample holder and operable to image the material sample within the material sample holder, wherein the accessory ring includes a third opening therethrough configured to support the imaging device.

17. The apparatus of claim 10, further comprising a hoist system coupled with the feed implement, wherein the hoist system is configured to selectively translate the feed implement between a raised position and a lowered position relative to the material sample holder.

18. A method of performing an analysis on a material sample using a rheological system, wherein the rheological system includes a rheometer probe, a sample holder holding a material sample therein, and a material feed implement, wherein the rheometer probe and material feed implement are each configured to extend into the sample holder, wherein the material feed implement is fluidly coupled with a material reservoir, the method comprising:
(a) lowering the rheometer probe into the sample holder, wherein the rheometer probe is at least partially submerged into the material sample;
(b) activating a rotation of the rheometer probe;
(c) determining a first rheological material characterization of the material sample;
(d) while the rheometer probe rotates, transferring a predetermined dose of an additive from the material reservoir into the sample holder using the material feed implement; and
(e) determining a second rheological material characterization of the material sample.

19. The method of claim 18, the method comprising:
transferring the material sample from the material reservoir to the sample holder using the material feed implement.

20. The method of claim 18, wherein the rheological system includes a material evacuation implement configured to extend into the sample holder and a disposal reservoir fluidly coupled with the material evacuation implement, the method comprising:
(a) deactivating the rotation of the rheometer probe; and
(b) transferring at least a portion of the material sample from the sample holder to the disposal reservoir.
